(19) United States
(12) Patent Application Publication
(10) Pub. No.: US 2025/0240315 A1
(43) Pub. Date: Jul. 24, 2025

(54) SIGNAL ANOMALY DETECTION DEVICE

(71) Applicant: CHENGDING INDUSTRIAL CO., LTD., Taoyuan City (TW)

(72) Inventor: CHENG-WEN YANG, Taoyuan City (TW)

(21) Appl. No.: 18/669,180

(22) Filed: May 20, 2024

(30) Foreign Application Priority Data
Jan. 19, 2024 (TW) 113102280

(51) Int. Cl. H04L 9/40; G07F 17/32

(52) U.S. Cl. CPC H04L 63/1425; G07F 17/3241; H04L 63/1441

(57) ABSTRACT

A signal anomaly detection device includes a first connector, an antenna, a second connector and a determining unit. The first connector has a first end that is connected to a first device to receive a first signal transmitted from the first device and a second end. The antenna is for sensing a second signal. The second connector has a first end that is for connecting to a second device and a second end. The determining unit is connected to the second ends of the first connector and the second connector, and the antenna, and is for selectively transmitting the first signal to the second device through the second connector based on whether the first signal is abnormal. If the determining unit receives the first signal through the first connector and the second signal sensed by the antenna is a high-frequency signal, the first signal is determined to be abnormal.

### BACKGROUND

### 1. Technical Field

This invention relates to a signal anomaly detection device, specifically to a device that detects whether pulse signals are abnormal.

### 2. Description of Related Art

In common amusement venues, many gaming machines offer games that the coins or bills may be inserted to try and win tickets or points as rewards. For example, slot machines such as one-armed bandits or fruit machines that give corresponding scores or rewards when coins are inserted, or coin pusher machines where the coins stacked inside the machine is being pushed down by the inserted coins. The commonality in these games is the attempt to gain more coins or points through gameplay to exchange for rewards.

However, due to technology advancement, some dishonest players try to use jammers to simulate the coin value signals of gaming machines, thereby tricking the machine into determining that coins or bills have been inserted without actually doing so, which triggers the gaming machine to operate and allows the attempts to gain rewards illegally.

Please refer to FIG. 1A, which shows a signal generated by a known coin insertion device when coins are inserted. Typically, a coin insertion device may have a sensing coil for detecting the coin value and authenticity of the inserted coins and/or an optical sensor for detecting the value and authenticity of inserted bills. Once the control unit in the coin insertion device confirms the coin value of the inserted coins or bills, a square wave signal with a working frequency is generated as shown in FIG. 1A, where the working frequency varies according to the coin value of the inserted coin. This square wave signal may be transmitted to a counting device inside the gaming machine connected to the coin insertion device. The counting device may count correspondingly based the inserted coin value which is determined by the working frequency of the square wave signal, for example, increasing the number of plays or game points to allow the gaming machine to be operated.

Please also refer to FIG. 1B, which shows a pulse signal that simulates the coin value by a known jammer. As shown in FIG. 1B, the jammer may generate a high-frequency signal simulating the square wave signal corresponds to the inserted coins or bills for the counting device. When the conversion period of this high-frequency signal precisely matches the working frequency of the square wave signal corresponds to the coin value, the counting device will operate accordingly, thereby allowing the gaming machine to operate without actual insertion of coins or bills and cause significant losses to the operators.

Therefore, detecting whether the signal corresponded to the coin value is abnormal (i.e., whether the signal is generated by illegal actions, such as by a jammer) is a goal that needs an urgent improvement for researchers in this field.

### SUMMARY

In view of this, one objective of the invention is to provide a signal anomaly detection device that detects whether pulse signals are abnormal, thereby generating corresponding contingency measures to reduce losses for operators.

To achieve the objective, one embodiment of the invention provides a signal anomaly detection device, including: a first connector, an antenna, a second connector, and a determining unit; the first connector, having a first end and a second end, the first end of the first connector for connecting to a first device to receive a first signal transmitted from the first device; the antenna, for sensing a second signal; the second connector, having a first end and a second end, the first end of the second connector for connecting to a second device; the determining unit, connecting to the second end of the first connector, the second end of the second connector and the antenna, and for selectively transmitting the first signal to the second device through the second connector based on whether the first signal being abnormal, wherein in response to the determining unit receiving the first signal through the first connector, if the determining unit receiving the second signal from the antenna and the second signal being a high-frequency signal, the first signal being determined being abnormal.

According to some embodiments of the invention, in response to the determining unit determining the first signal being abnormal, the determining unit prohibits transmitting the first signal through the second connector to the second device.

According to some embodiments of the invention, in response to the determining unit determining the first signal being abnormal, the determining unit further transmits a disable signal through the second connector to the second device to disable the second device.

According to some embodiments of the invention, in response to the determining unit determining the first signal being abnormal, the determining unit pulls the first signal down to a logic low level then transmits the first signal with the logic low level through the second connector to the second device.

According to some embodiments of the invention, the signal anomaly detection device further including: a first wire, with a first end and a second end; the second end of the first wire connecting to the determining unit and the first end of the first wire for connecting to an alarm device; wherein in response to the determining unit determining the first signal being abnormal, the determining unit triggering the alarm device through the first wire.

According to some embodiments of the invention, in response to the determining unit receiving the first signal through the first connector, if the determining unit fails to receive the second signal sensed by the antenna, the first signal is determined to be normal.

According to some embodiments of the invention, in response to the determining unit determining the first signal being normal, the determining unit transmits the first signal through the second connector to the second device.

According to some embodiments of the invention, the first device is a coin and/or bill input device and the first signal is a signal that corresponds to a coin value of the inserted coin and/or bill being input into the coin and/or bill input device; the second device is a counting device and the counting device is for counting based on the coin value corresponded to the first signal.

According to some embodiments of the invention, the first connector of the signal anomaly detection device is selectively plugged into the first device and/or the second connector of the signal anomaly detection device is selectively plugged into the second device.

According to some embodiments of the invention, in response to the frequency of the second signal being greater than 30 KHz, the determining unit determines the second signal is the high-frequency signal.

In summary, through various embodiments of the signal anomaly detection device provided by this invention, it may effectively determine whether the signal received by the coin and/or bill input device which corresponds to the coin value is a normal signal or an abnormal simulated signal. By generating corresponding various contingency measures upon receiving an abnormal signal, it effectively reduces losses for operators. Additionally, the signal anomaly detection device may be selectively plugged between various devices, thereby enables the detection of signal abnormalities without altering the design of the circuit boards in the coin and/or bill input devices and gaming machines and significantly reduces the cost of design alteration.

### BRIEF DESCRIPTION OF THE DRAWINGS

FIG. 1A shows the signal generated by a known coin insertion device when coins are inserted.

FIG. 1B shows the pulse signal that simulates coin values by a known jammer.

FIG. 2 is a block diagram of a signal anomaly detection device according to a first embodiment of the invention.

FIG. 3 is a block diagram of a signal anomaly detection device according to a second embodiment of the invention.

FIG. 4 is a block diagram of a signal anomaly detection device according to a third embodiment of the invention.

FIG. 5 is a block diagram of a signal anomaly detection device according to a fourth embodiment of the invention.

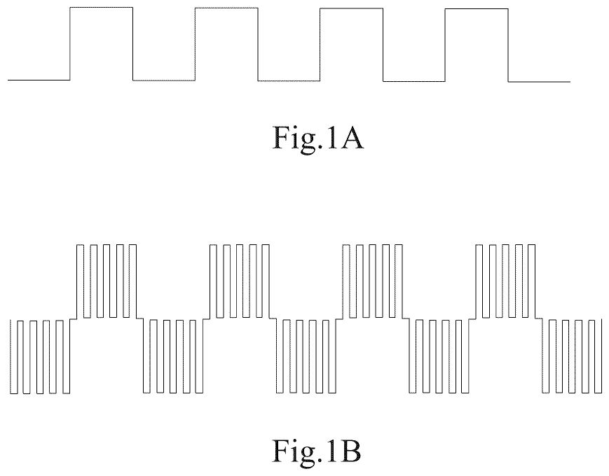

### DESCRIPTION OF THE EXEMPLARY EMBODIMENTS

In order to make the above and other objectives, features, and advantages of the invention clearer and more comprehensible, the following description will describe preferred embodiments of the invention in detail, accompanied by the attached drawings.

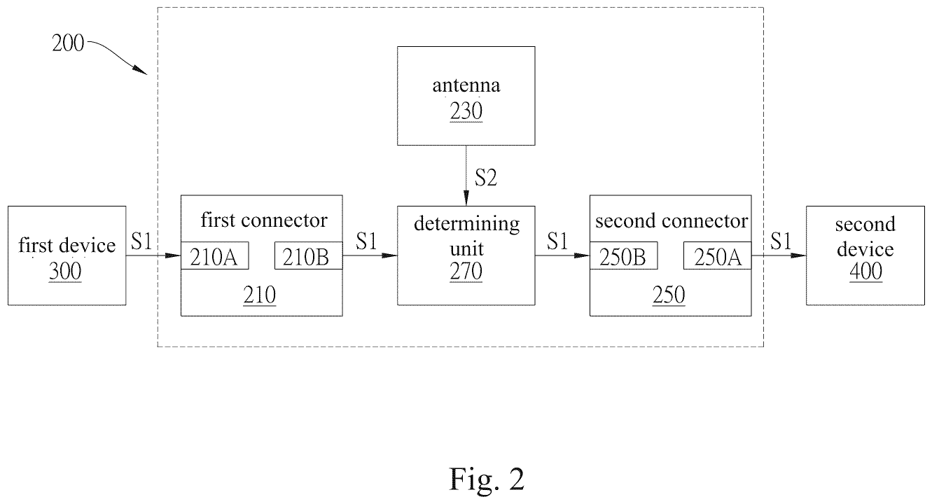

Please refer to FIG. 2, which is a block diagram of a signal anomaly detection device 200 according to the first embodiment of the invention. Specifically, the signal anomaly detection device 200 is applicable for detecting signals of the coin value from a first device 300 (e.g., a coin and/or bill input device) and determining whether these signals are abnormal, thereby producing the corresponding contingency measures for a second device 400 (e.g., a counting device within a gaming machine). In this embodiment, the signal anomaly detection device 200 may include a first connector 210, an antenna 230, a second connector 250 and a determining unit 270. The first connector 210 has a first end 210A and a second end 210B. The first end 210A is for connecting to the first device 300 to receive a first signal S1 transmitted from the first device 300. The antenna 230 is for sensing a second signal S2. The second connector 250 has a first end 250A and a second end 250B. The first end 250A is for connecting to the second device 400. The determining unit 270 connects to the second end 210B of the first connector 210, the second end 250B of the second connector 250 and the antenna 230, and the determining unit 270 for selectively transmitting the first signal S1 to the second device 400 based on whether the first signal S1 is abnormal.

Specifically, the first device 300 may be a coin and/or bill input device for receiving coins and/or bills which determines the authenticity and coin value of the coins and/or bills and generates a corresponding signal (i.e., the first signal S1) based on the coin value of the coins and/or bills. The second device 400 may be a counting device within the gaming machine. The counting device is for performing the counting operations based on the coin value corresponded to the first signal S1, such as increasing the number of game plays or game points. Typically, under the circumstances without the signal anomaly detection device 200 provided by the invention, the second device 400 may directly connect to the first device 300, meaning that the counting device may be directly connected to the coin and/or bill input device and perform counting operations based on whether it receives the first signal S1 corresponded to the coin value from the coin and/or bill input device. However, as previously mentioned, since jammers can produce high-frequency signals simulating the coin value corresponded to the counting device, the counting device may still determine that it has received the first signal S1 without any coins and/or bills being actually received by the coin and/or bill input device, thereby triggers counting actions.

Therefore, the signal anomaly detection device 200 provided by this invention may be connected between the first device 300 and the second device 400 to detect whether the first signal S1 transmitted by the first device 300 is abnormal, thereby deciding whether to continue transmitting the first signal S1 to the second device 400 or to perform other processing on the first signal S1. In this embodiment, the signal anomaly detection device 200 may be selectively plugged into the first device 300 through the first connector 210 and/or selectively plugged into the second device 400 through the second connector 250. The first connector 210 and/or the second connector 250 may be adjusted according to the specifications of the controller or circuit board they connect to, thereby being suitable for connecting to any type of devices. In this way, simply by connecting the first device 300 through the first connector 210 and the second device 400 through the second connector 250, the function of detecting signal abnormalities may be activated thereby a plug-and-play effect is offered. Additionally, through the design that the signal anomaly detection device may be selectively plugged between various devices, the functionality of detecting signal abnormalities may be realized without altering the design of the circuit boards in the coin and/or bill input devices and gaming machines, thus saving the cost of design alterations.

In one embodiment, in response to the determining unit 270 receiving the first signal S1 through the first connector 210, if the determining unit 270 also receives a second signal S2 sensed by the antenna 230 and the second signal S2 is a high-frequency signal, the first signal S1 is determined to be abnormal. As previously mentioned, typical jammers work by generating high-frequency signals and transmitting them wirelessly (e.g., through an antenna) to the counting device. Thus, if there is an action using a jammer to generate a simulated signal, when the first connector 210 of the signal anomaly detection device 200 receives the first signal S1 (at this time a simulated signal), the antenna 230 of the signal anomaly detection device 200 will also receive the same signal. Therefore, the determining unit 270 may determine whether the first signal S1 is a simulated signal based on whether the second signal S2 sensed by the antenna 230 is a high-frequency signal, i.e., whether the first signal S1 is abnormal. If the first signal S1 is received simultaneously with the second signal S2 and the second signal S2 is a high-frequency signal, it can be confirmed that the first signal S1 at that time is a simulated signal and the first signal S1 is determined to be abnormal.

In one embodiment, in response to the determining unit 270 determining the first signal S1 being abnormal, the determining unit 270 prohibits transmitting the first signal S1 through the second connector 250 to the second device 400. In this way, the second device 400 will not receive the abnormal first signal S1, thereby not being triggered to perform counting operations.

On the other hand, in response to the determining unit 270 receiving the first signal S1 through the first connector 210, if the determining unit 270 does not receive the second signal S2 sensed by the antenna 230, the first signal S1 is determined to be normal. Specifically, when the determining unit 270 receives the first signal S1, if the antenna 230 does not detect the presence of any other external signals, it indicates that the first signal S1 is indeed generated by the first device 300 (i.e., generated by the coin and/or bill input device based on the coins and/or bills inserted), which represents there is an actual coin and/or bill insertion behavior, thus the first signal S1 is a normal coin value signal. At this time, the determining unit 270 may directly transmit the first signal S1 through the second connector 250 to the second device 400 and enables the second device 400 to perform corresponding operations based on the coin value of the first signal S1 (e.g., based on the working frequency of the first signal S1), such as counting.

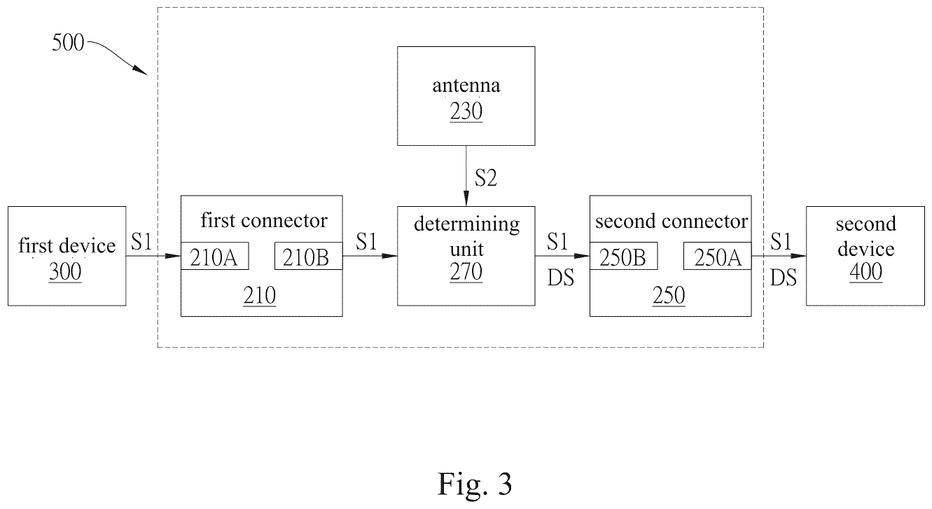

Please refer to FIG. 3, which is a block diagram of a signal anomaly detection device 500 according to the second embodiment of the invention. The structure and operation of signal anomaly detection device 500 are similar to those of signal anomaly detection device 200, with identical component symbols representing similar functions and operations, which will not be repeated here. In this embodiment, in response to the determining unit 270 determining the first signal S1 being abnormal, in addition to prohibiting the transmission of the first signal S1 through the second connector 250 to the second device 400, the determining unit 270 also transmits a disable signal DS through the second connector 250 to disable the second device 400. Specifically, in this embodiment, when the determining unit 270 detects that the first signal S1 is abnormal, it may generate a disable signal DS to the second device 400, thus shutting down the second device 400 (e.g., the counting device) or other devices connected to the second device 400 (e.g., a controller connected to the counter or the entire gaming machine that includes the counting device). In this way, dishonest players from continuing using jammers for improper gaming behavior may be prevented directly.

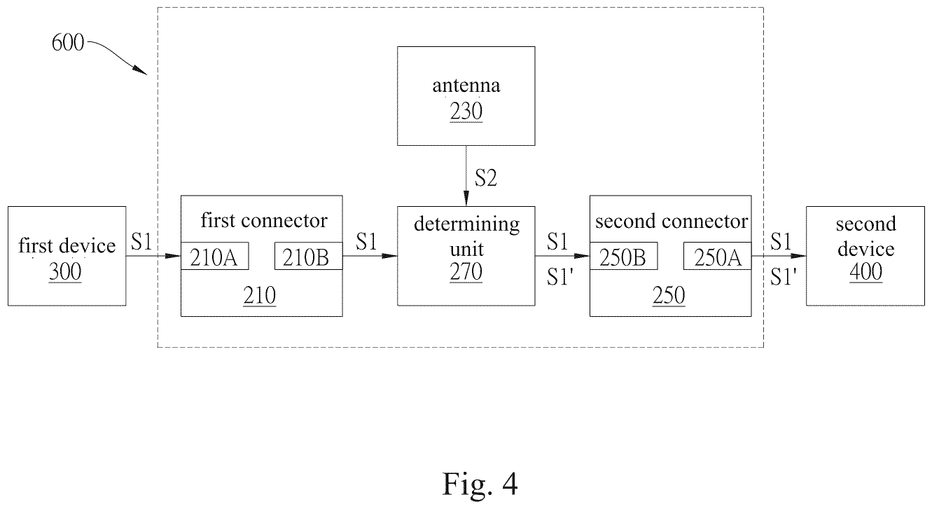

Please refer to FIG. 4, which is a block diagram of a signal anomaly detection device 600 according to the third embodiment of the invention. The structure and operation of signal anomaly detection device 600 are similar to those of signal anomaly detection device 200, with identical component symbols representing similar functions and operations, which will not be repeated here. In this embodiment, in response to the determining unit 270 determining the first signal S1 being abnormal, the determining unit 270 pulls the first signal S1 down to a logic low level (e.g., ground) then transmits the first signal S1′ with the logic low level to the second device 400 through the second connector 250. When the second device 400 only receives the first signal S1′ with the logic low-level instead of a fixed-frequency square wave signal, it may determine that the received first signal S1′ is abnormal, thereby not to proceed on counting and triggering other operations, such as shutting down the second device 400, pausing the operation of the second device 400 or triggering an alarm device (not shown in the figures).

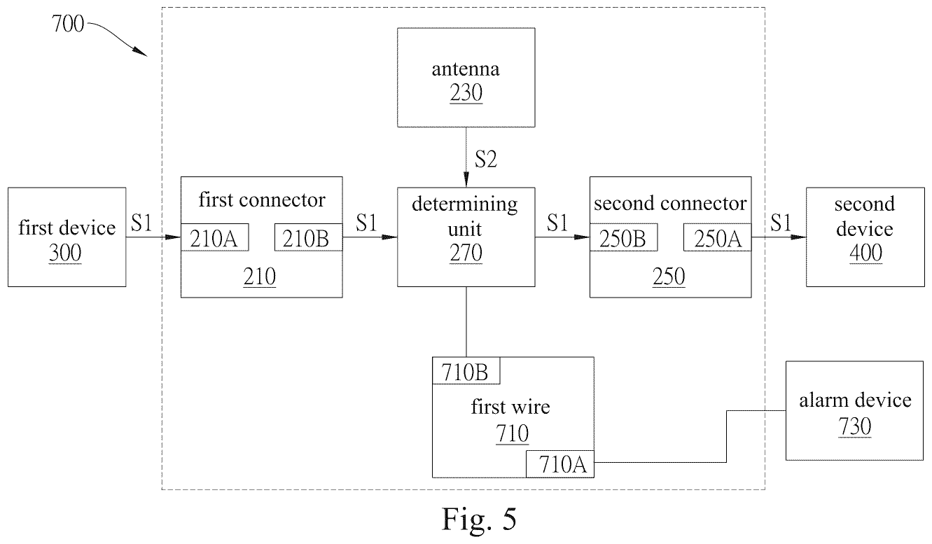

Please refer to FIG. 5, which is a block diagram of a signal anomaly detection device 700 according to the fourth embodiment of the invention. The structure and operation of signal anomaly detection device 700 are similar to those of signal anomaly detection device 200, with identical component symbols representing similar functions and operations, which will not be repeated here. In this embodiment, the signal anomaly detection device 700 also includes a first wire 710 having a first end 710A and a second end 710B. The second end 710B of the first wire 710 connects to the determining unit 270 and the first end 710A of the first wire 710 is for connecting to an alarm device 730. In response to the determining unit 270 determining the first signal S1 being abnormal, the determining unit 270 triggers the alarm device 730 through the first wire 710. In some cases, since the power supplies of multiple gaming machines are connected together, if one gaming machine is shut down due to detecting abnormal behavior, it could also shut down other gaming machines that operate normally and causes additional losses. Therefore, in this embodiment, when the signal anomaly detection device 700 detects abnormal behavior, it may notify the connected alarm device 730 via the additional first wire 710, thereby generates corresponding contingency measures without affecting other gaming machines.

In summary, through various embodiments of the signal anomaly detection device provided by the invention, it is possible to effectively determine whether the signal corresponded to the coin value received by the coin and/or bill input device is a normal signal or an abnormal simulated signal, thereby generates various different contingency measures based on the reception of an abnormal signal. It effectively reduces losses for operators. Additionally, the signal anomaly detection device may be selectively plugged between various devices, thereby under the circumstances of without altering the design of the circuit boards in the coin and/or bill input devices and gaming machines, the detection of pulse signal abnormalities is enabled and significantly reduces the cost of design alterations.

Although this invention has been disclosed in preferred embodiments, it is not intended to limit scope of the invention. Any person skilled in the art may make various changes and modifications without departing from the spirit and scope of the invention, therefore the scope of the invention should be determined by the appended claims.

What is claimed is:

1. A signal anomaly detection device, comprising:
a first connector, having a first end and a second end, wherein the first end of the first connector being for connecting to a first device to receive a first signal transmitted from the first device;
an antenna, for sensing a second signal;
a second connector, having a first end and a second end, wherein the first end of the second connector being for connecting to a second device; and
a determining unit, connecting to the second end of the first connector, the second end of the second connector and the antenna, for selectively transmitting the first signal to the second device through the second connector based on whether the first signal being abnormal;
wherein, in response to the determining unit receiving the first signal through the first connector, if the determining unit receiving the second signal sensed by the antenna and the second signal being a high-frequency signal, the first signal being determined to be abnormal.

2. The signal anomaly detection device of claim 1, wherein in response to the determining unit determining the first signal being abnormal, the determining unit prohibits transmitting the first signal through the second connector to the second device.

3. The signal anomaly detection device of claim 2, wherein in response to the determining unit determining the first signal being abnormal, the determining unit also transmits a disable signal through the second connector to the second device to disable the second device.

4. The signal anomaly detection device of claim 1, wherein in response to the determining unit determining the first signal being abnormal, the determining unit pulls the first signal down to a logic low level then transmits the first signal with the logic low level through the second connector to the second device.

5. The signal anomaly detection device of claim 1, further comprising:
a first wire, having a first end and a second end, the second end of the first wire connecting to the determining unit and the first end of the first wire for connecting to an alarm device, wherein in response to the determining unit determining the first signal being abnormal, the determining unit triggering the alarm device through the first wire.

6. The signal anomaly detection device of claim 1, wherein in response to the determining unit receiving the first signal through the first connector, if the determining unit fails to receive the second signal sensed by the antenna, the first signal is determined to be normal.

7. The signal anomaly detection device of claim 6, wherein in response to the determining unit determining the first signal being normal, the determining unit transmits the first signal through the second connector to the second device.

8. The signal anomaly detection device of claim 1, wherein the first device is a coin and/or bill input device and the first signal corresponds to a signal of a coin value input to the coin and/or bill input device, and the second device is a counting device and the counting device is for counting based on the coin value corresponded to the first signal.

9. The signal anomaly detection device of claim 1, wherein the first connector of the signal anomaly detection device is selectively plugged into the first device and/or the second connector of the signal anomaly detection device is selectively plugged into the second device.

10. The signal anomaly detection device of claim 1, wherein in response to the frequency of the second signal exceeds 30 KHz, the determining unit determines the second signal to be the high-frequency signal.
